(19) United States
(12) Patent Application Publication
(10) Pub. No.: US 2019/0134931 A1
(43) Pub. Date: May 9, 2019

(54) PROCESSING METHOD AND PROCESSING DEVICE FOR LENS MOLD CORE

(71) Applicant: AAC Technologies Pte. Ltd., Singapore city (SG)

(72) Inventors: Niels Christian Roemer Holme, Farum (DK); Bingke Zhu, Shenzhen (CN)

(21) Appl. No.: 16/177,490

(22) Filed: Nov. 1, 2018

(30) Foreign Application Priority Data
Nov. 3, 2017 (CN) 201711070945.0

(51) Int. Cl. B29D 11/00; B23K 26/362

(52) U.S. Cl. CPC B29D 11/0048; B23K 26/362; B29D 11/00942

(57) ABSTRACT

A processing method and a processing device for lens mold core, the processing method includes steps of: softening a mold core base; surface treating a work surface of the mold core base by lighting; processing the work surface by removing material. When processing the lens mold core with this method, since the mold core base is softened and the work surface is surface treated by lighting, the processing difficulty of the mold core base is decreased, and thus a tool having a smaller radius and a higher feed rate can be adopted for processing. The tool having the smaller tool radius allows a more precise structure, and the higher feed rate imparts the work surface with a smaller roughness, thereby imparting the lens mold core with a higher processing precision.

### TECHNICAL FIELD

The present disclosure relates to the field of mold processing technologies and, more particularly, to a processing method and a processing device for a lens mold core.

### BACKGROUND

As for a product machined by using a mold, correctness of the shape of the product depends on the manufacturing precision of the mold in a great extent. Taking a lens used in wafer-level lens as an example, the processing precision of the lens depends more on the manufacturing precision of a lens mold core.

In the related art, the lens mold core is generally processed by devices such as ultra-precision lathe, high-precision grinding machine and electric discharge machines, and processing precisions of the above three devices are 0.1 μm, 1 μm and 20 μm, respectively. However, the devices having the above precisions still cannot guarantee a precision of the lens, and thus deficiencies, such as misalignment of the optical axis of the lens and poor image quality, often occur when assembling a lens module.

### BRIEF DESCRIPTION OF DRAWINGS

FIG. 1 illustrates a flow diagram of a processing method for a lens mold core according to an embodiment of the present disclosure;

FIG. 2 illustrates a processing schematic diagram of a lens mold core according to an embodiment of the present disclosure;

FIG. 3 illustrates a plot of form errors of convex mold cores processed in different cuts according to an embodiment of the present disclosure; and

FIG. 4 illustrates a plot of form errors of concave mold cores processed in different cuts according to an embodiment of the present disclosure.

### REFERENCE SIGNS

2—mold core base;
22—work surface;
4—light generation apparatus;
6—processing apparatus.

The drawings herein are incorporated into and constitute a part of the present specification, which show the embodiments of the present disclosure and illustrate the principles of the present disclosure together with the specification.

### DESCRIPTION OF EMBODIMENTS

The present disclosure will be further illustrated with reference to the accompanying drawings and embodiments.

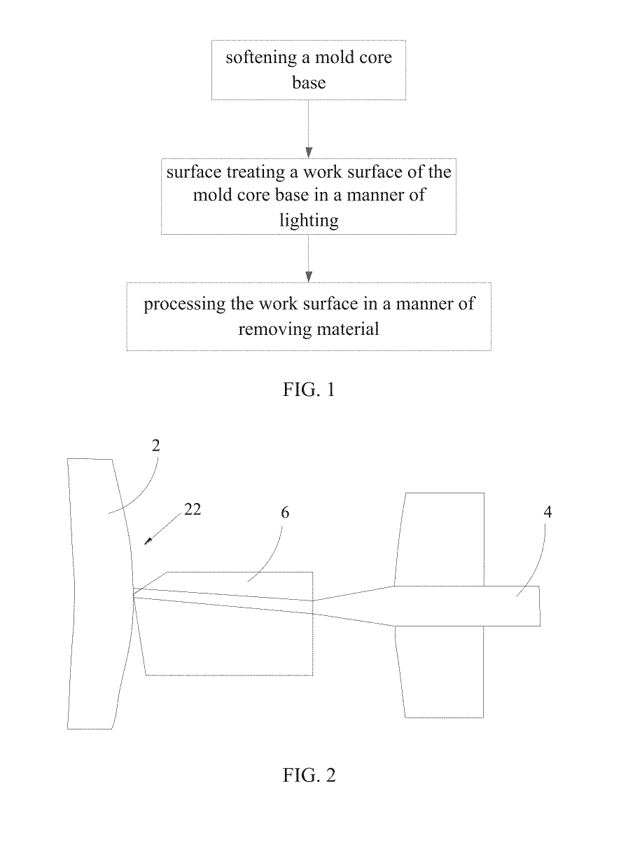

With reference to FIGS. 1 and 2, FIG. 1 illustrates a flow diagram of a processing method for a lens mold core, and FIG. 2 illustrates a processing schematic diagram of the lens mold core.

The present disclosure provides a processing method for a lens mold core. The lens mold core can be used to mold a lens, and the lens is generally used in a lens module such as a wafer-level lens module.

The method includes the following steps:

softening a mold core base 2;

surface treating a work surface 22 of the mold core base 2 after softening the mold core base 2; and

processing the work surface 22 by removing material after the work surface 22 is surface treated.

The softening of the mold core base 2 can be performed by a softening manner such as spheroidizing annealing, normalizing, stress relief annealing and so on. The above softening manner can change the metallographic structure of the base, thereby changing a hardness of the base, so as to achieve the purpose of softening.

The work surface 22 can be surface treated in a manner of lighting. Lighting is a non-contact surface treatment manner, which can selectively surface treat a surface of the mold core base 2, besides, the energy effect is concentrated, the treatment time is short, an heat affected area is small, and the impact on deformation of the mold core base is small.

In an exemplary embodiment, the lighting can be performed a manner of laser irradiation. Laser is an electromagnetic wave having a uniform phase, a constant wavelength and an extremely strong directivity, an interaction between the laser and metal can quickly and locally heat the work surface 22 of the mold core base 2 and change a surface structure of the metal, thereby changing mechanical property of the work surface 22 and reducing processing difficulty.

In another exemplary embodiment, the lighting can be performed in a manner of infrared light irradiation. Infrared light is an electromagnetic wave having a longer wavelength than the visible light. Similarly, the infrared light can also quickly and locally heat the work surface 22 of the mold core base 2 and change mechanical property of the work surface 22, thereby reducing processing difficulty.

Surface treatment of the work surface 22 can meanwhile remove oil, impurities and oxide skins, etc.

According to the above description, when processing the work surface 22, since the mold core base 2 is softened and the work surface 22 of the mold core base 2 is surface treated in a manner of lighting, the processing difficulty of the mold core base 2 is decreased, and thus a tool having a smaller radius and a higher feed rate can be adopted for processing. The smaller radius of the tool allows a more precise structure, and the higher feed rate can impart the work surface 22 with a smaller roughness, thereby imparting the lens mold core with a higher processing precision.

The lens mold core includes a convex mold core, a concave mold core and a cavity formed by the convex mold core and the concave mold core. The cavity is configured that a raw material (for example, glass, resin and the like) for manufacturing the lens can be injected in the cavity. Therefore, it is necessary to remove material from the mold core base 2 so as to form a desired structure. There are various manners to remove the material, for example, electrosparking, wire cutting, etc. In an embodiment, the manner to remove material of the work surface is cutting.

The processing precision when cutting is illustrated with reference to the following processing examples, and the form errors after processing can be seen in Table 1.

TABLE 1

| Mold core (R = 1 mm) | Cut No. | Form error (nm) |
|---|---|---|
| Convex mold core | 5 | 104 |
| | 6 | 142 |
| | 7 | 158 |
| | 8 | 186 |
| | 9 | 141 |
| Concave mold core | 11 | 223 |
| | 12 | 310 |
| | 13 | 237 |
| | 14 | 295 |

Note:
R represents the radius of the convex mold core sphere or the concave mode core sphere.

As can be seen from Table 1, the machined convex mold core has a very small form error, and the measured results show very good consistency from cut to cut.

It can be further known from Table 1 that form errors and roughness of the concave mold cores also show every good consistency from cut to cut, and a maximum difference between the form errors from five consecutive cuts is 87 nm. Compared with the convex mold core, a greater form error occurs in a middle part of the concave mold core, which is caused by wear of the tool having the smaller radius when rough cutting.

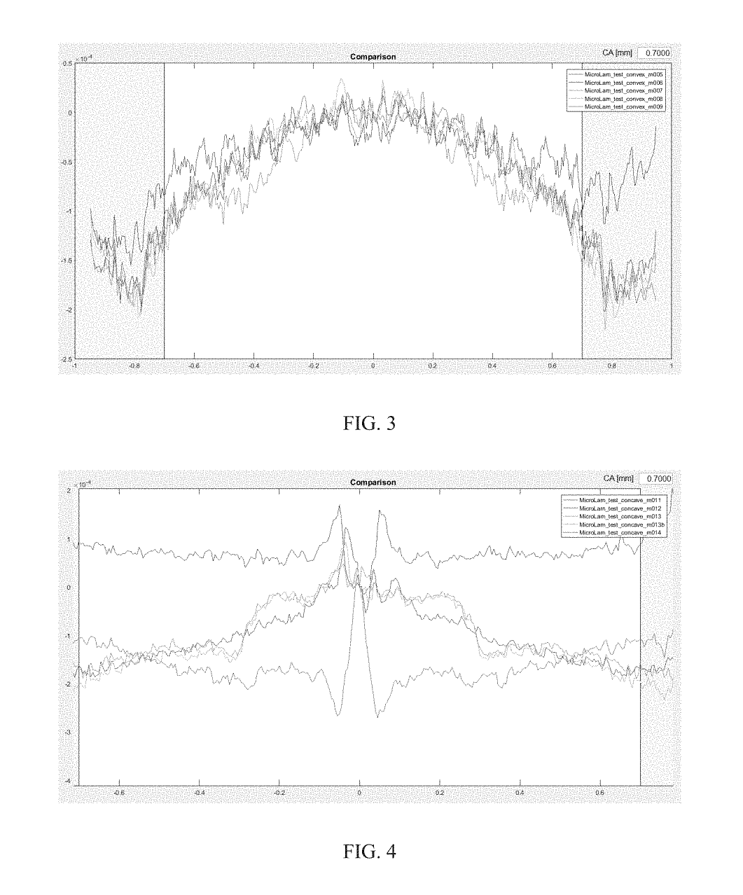

With reference to FIGS. 3-4, FIG. 3 illustrates a plot of form errors of convex mold cores processed in different cuts, and FIG. 4 illustrates a plot of form errors of concave mold cores processed in different cuts.

When surface treating the work surface, another optional solution can be performed, that is, the work surface can be surface treated and processed at the same time, that is, the infrared light beam and the laser beam are irradiated on a portion of the work surface 22 that is being processed by the tool, this solution allows the surface treatment and processing to be parallel performed, thereby saving processing time and improving processing efficiency.

Further, when cutting, the cutting tool can optionally cut the work surface at a cutting angle of less than 30°, and in this case, the cutting force can be decomposed into a first component force parallel to the work surface and a second component force perpendicular to the work surface. According to the parallelogram law of force, the first component force is greater than the second component force. The first component force is used to remove material of the work surface, and the smaller the cutting angle is, the greater the first component force is. When cutting, a greater cutting force can decrease the roughness of the work surface.

With reference to Table 2, which shows the microscopic unevenness (Rms) and surface roughness (Ra) of the convex mold core processed at the cutting angles of 0°, 10°, 20° and 30°, respectively.

TABLE 2

| Cutting angle | 0° | 10° | 20° | 30° |
|---|---|---|---|---|
| Rms (nm) | 4.148 | 3.195 | 3.944 | 3.523 |
| Ra (nm) | 3.162 | 2.423 | 2.992 | 2.590 |

It can be seen from Table 2 that the microscopic unevenness and surface roughness of the convex mold core processed at each cutting angle are less than 5 nm.

The present disclosure further provides a processing device for a lens mold core, configured to process the lens mold core using the processing method in any of the above embodiments. The processing device includes a softening apparatus (not shown), a light generation apparatus 4, and a processing apparatus 6.

The softening apparatus is used to soften the mold core base 2, and the softening apparatus may be a spheroidizing annealing apparatus or a normalizing apparatus. The softening apparatus can change the metallographic structure of the mold core base 2, thereby changing the hardness of the base and achieving the purpose of softening.

The light generation apparatus 4 performs surface treatment on the work surface 22 of the mold core base 2 in a manner of lighting, for example to heat the work surface 22 and remove impurities, oil stain and oxide skins, etc., and the processing difficulty can be decreased after surface treatment of the work surface 22.

The processing apparatus 6 is used to process the work surface, and the processing is performed by removing material from the work surface.

According to the above description, since the mold core base 2 is softened and the work surface 22 is surface treated, the processing difficulty is decreased and thus a tool having a smaller radius and a higher feed rate can be used for processing. The smaller tool radius allows a more precise structure, and the higher feed rate imparts the work surface with a smaller roughness, thereby imparting the lens mold core with a higher processing precision.

The light generation apparatus 4 can adopt an infrared light generator or a laser generator, both of which can emit a light beam that interacts with the metal surface, thereby changing the mechanical property of the work surface 22 and reducing the processing difficulty.

Optionally, the processing and the surface treatment can be performed synchronously, for example, the light generation apparatus 4 generates a light beam, and the light beam is irradiated on a portion of the work surface 22 that is being processed by the processing apparatus 6. This solution allows the surface treatment and processing to be parallel performed, thereby saving processing time and improving processing efficiency.

The processing apparatus 6 may include a control part and a processing part, the control part is in communication connection with the processing part. The control part includes a control chip, and a control program is written in the control chip. The processing part acts and cuts the work surface 22 according to the control program. The control part allows a precise action of the processing part, thereby further improving the processing precision of the lens mold core.

The processing part includes a cutting tool, the cutting tool is a diamond tool which possesses advantages such as high hardness and good wear resistance, etc. In some other embodiments, the cutting tool can also be made of other materials.

Further, the cutting angle of the cutting tool can be set to be less than 30°. When the cutting angle is less than 30°, the cutting force can be decomposed into a first component force parallel to the work surface 22 and a second component force perpendicular to the work surface 22. According to the parallelogram law of force, the first component force is greater than the second component force. The first component force is used to remove material of the work surface 22, and the smaller the cutting angle is, the greater the first component force is. When cutting, a greater cutting force can decrease the roughness of the work surface 22.

The above description only illustrates preferred embodiments of the present disclosure and is not intended to limit the present disclosure. Various modifications and changes may be made by those skilled in the art. Any modifications, equivalent replacements, improvements and the like made within the principles of the present disclosure should be included in the protection scope of the present disclosure.

What is claimed is:

1. A processing method for a lens mold core, comprising steps of:
softening a mold core base;
surface treating a work surface of the mold core base in a manner of lighting; and
processing the work surface in a manner of removing material.

2. The processing method as described in claim 1, wherein the manner of lighting is a manner of infrared light irradiation or a manner of laser irradiation.

3. The processing method as described in claim 1, wherein the step of surface treating the work surface and the step of processing the work surface in a manner of removing material are performed simultaneously.

4. The processing method as described claim 1, wherein the manner of removing material is cutting.

5. The processing method as described in claim 4, wherein the work surface is processed in a manner of cutting at a cutting angle of less than 30°.

6. A processing device for a lens mold core using the processing method according to claims 1 comprising:
a softening apparatus, used for softening the mold core base;
a light generation apparatus, used for surface treating the work surface of the mold core base in a manner of lighting; and
a processing apparatus, used for processing the work surface in a manner of removing material.

7. A processing device for a lens mold core using the processing method according to claims 2 comprising:
a softening apparatus, used for softening the mold core base;
a light generation apparatus, used for surface treating the work surface of the mold core base in a manner of lighting; and
a processing apparatus, used for processing the work surface in a manner of removing material.

8. A processing device for a lens mold core using the processing method according to claims 3, comprising:
a softening apparatus, used for softening the mold core base;
a light generation apparatus, used for surface treating the work surface of the mold core base in a manner of lighting; and
a processing apparatus, used for processing the work surface in a manner of removing material.

9. A processing device for a lens mold core using the processing method according to claims 4, comprising:
a softening apparatus, used for softening the mold core base;
a light generation apparatus, used for surface treating the work surface of the mold core base in a manner of lighting; and
a processing apparatus, used for processing the work surface in a manner of removing material.

10. A processing device for a lens mold core using the processing method according to claims 5, comprising:
a softening apparatus, used for softening the mold core base;
a light generation apparatus, used for surface treating the work surface of the mold core base in a manner of lighting; and
a processing apparatus, used for processing the work surface in a manner of removing material.

11. The processing device as described in claim 6, wherein the light generation apparatus is an infrared light generator or a laser generator.

12. The processing device as described in claim 6, wherein the processing apparatus comprises a control part and a processing part, the control part is in communication connection with the processing part, the control part is used to output a control signal, and the processing part is used to process the work surface according to the control signal.

13. The processing device as described in claim 12, wherein the processing part comprises a cutting tool and the cutting tool is a diamond tool.

14. The processing device as described in claim 13, wherein a cutting angle of the cutting tool is less than 30°.
